(19) United States
(12) Patent Application Publication
(10) Pub. No.: US 2012/0065806 A1
(43) Pub. Date: Mar. 15, 2012

(54) METHOD FOR MEASURING ENERGY USAGE IN AN APPLIANCE

(75) Inventors: Steven Michael Recio, Louisville, KY (US); Gautam Subbarao, Louisville, KY (US); Richard Dean Suel, II, Louisville, KY (US); Chad Michael Helms, Louisville, KY (US)

(73) Assignee: GENERAL ELECTRIC COMPANY, Schenectady, NY (US)

(21) Appl. No.: 13/102,162

(22) Filed: May 6, 2011

(51) Int. Cl. G06F 1/28

(52) U.S. Cl. 700/298

(57) ABSTRACT

The present subject matter relates to methods and apparatus for measuring energy usage in an appliance, particularly a washing appliance. A display, that may be a home energy monitor, is associated with the appliance. The appliance may include an AC-DC power supply and a controllable inverter configured to supply power to a motor associated with the appliance. Real power consumption is calculated by a controller that may also be used to control the inverter and other operational aspects of the appliance and causes the calculated real power to be displayed on the display.

### FIELD OF THE INVENTION

The present subject matter relates to energy usage monitoring. More particularly, the present subject matter relates to methodologies for accurately measuring the real time power and energy usage of an appliance, particularly a washing machine including a motor and inverter.

### BACKGROUND OF THE INVENTION

Energy conservation continues to be an ongoing concern for many consumers. Such concerns have extended to many divergent areas from providing more fuel efficient vehicles including alternate fuel vehicles such as electric vehicles and now including concerns such as energy consumption by home appliances.

Prior known efforts with respect to appliance energy conservation have included such as selective activation of features including, for example, manually opening a dishwasher door to permit air drying of the wash load rather than permitting the heating element to turn on. Certain devices have provided an indication of energy usage by providing a visual indication of the energy that would be consumed by selected operations. For example U.S. Pat. No. 4,241,400 to Kiefer entitled “Microprocessor Based Control Circuit For Washing Appliances” discloses a display device corresponding to a row of LEDs mounted on a washer display panel that indicates a relative amount of energy usage. Another such device is described in US Published Patent Application Number 2010/0146712 A1 to Finch, et al. entitled “Energy Management of Clothes Washer Appliance.”

Many prior energy usage indications provide a certain level of information to the consumer, but are often based on average power consumption and are generally based on empirical estimates and not real time measurements. It would therefore be advantages to provide a Home Energy Monitor (HEM) arrangement that may be associated with an appliance that can accurately report on how much energy the appliance is actually using and to instantaneously display such usage information to the consumer.

### BRIEF DESCRIPTION OF THE INVENTION

Aspects and advantages of the invention will be set forth in part in the following description, or may be obvious from the description, or may be learned through practice of the invention.

The present subject matter relates to a method for measuring energy usage in an appliance. The method provides an appliance with an AC-DC converter configured to receive an alternating current input voltage and to produce a high voltage direct current voltage and an inverter configured to receive the high voltage direct current produced by the AC-DC converter and to provide a controllably variable alternating current output voltage.

The method further provides a controller configured to provide inverter controlling signals to the inverter and to receive energy consumption related signals based at least in part on energy usage of the inverter. Such method further provides a display coupled to the controller and provides for configuring the controller to calculate real time power consumption and to cause the calculated results to be displayed on the display. In selected embodiments, the display may be associated with an appliance, particularly a washer control panel while in other embodiments the display may be coupled to the controller through a wireless connection, and, in particular, correspond in such instances to a home energy monitor.

In selected embodiments, the method further comprises coupling a variable speed motor to the inverter to receive power therefrom and configuring the controller to calculate real time power consumption based on the output power of the inverter delivered to the motor. In certain such embodiments, the variable speed motor may be provided as an electronically commutated motor.

In other embodiments, the method further comprises coupling a variable speed motor to the inverter to receive power there from, associating a speed sensor with the motor and configuring the controller to calculate real time power consumption based on the speed of the motor and the torque produced by the motor.

In still other embodiments, the method further comprises coupling a variable speed motor to the inverter to receive power there from and configuring the controller to calculate real time power consumption based on the current delivered to the motor by the inverter and an assumed value of motor impedance.

In yet still further embodiments, the method further comprises configuring the controller to calculate real time power consumption based on the high voltage direct current voltage from the AC-DC converter and a ripple voltage thereon. In still further alternate embodiments, the method further comprises configuring the controller to calculate real time power consumption based on the current and voltage delivered from the AC-DC converter to the inverter. And in still further embodiments, the method further comprises configuring the controller to calculate real time power consumption based on inertia and out of balance mass to calculate power used to spin a basket associated with the appliance at selected speeds and accelerating from one speed to another.

The present subject matter also relates to an appliance, particularly a washing appliance, having an AC-DC converter configured to receive an alternating current input voltage and to produce a high voltage direct current voltage that is then applied to an inverter configured to provide a controllably variable alternating current output voltage. The appliance also includes a controller configured to provide inverter controlling signals to the inverter and to receive energy consumption related signals based at least in part on energy usage of the inverter and a display coupled to the controller. In such embodiments, the controller is configured to calculate real time power consumption and to cause the calculated results to be displayed on the display.

In certain embodiments, the display, which may be a home energy monitor, is wirelessly coupled to the controller. In particular embodiments, the appliance may further include a control panel associated with the display that is configured to receive user commands to direct operations of the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is an exemplary schematic representation of a portion of a washer control and display circuit and home energy monitor in accordance with present technology; and

FIG. 2 is a representation of an exemplary washing appliance and home energy monitoring system in accordance with present technology.

Repeat use of reference characters throughout the present specification and appended drawings is intended to represent same or analogous features or elements of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

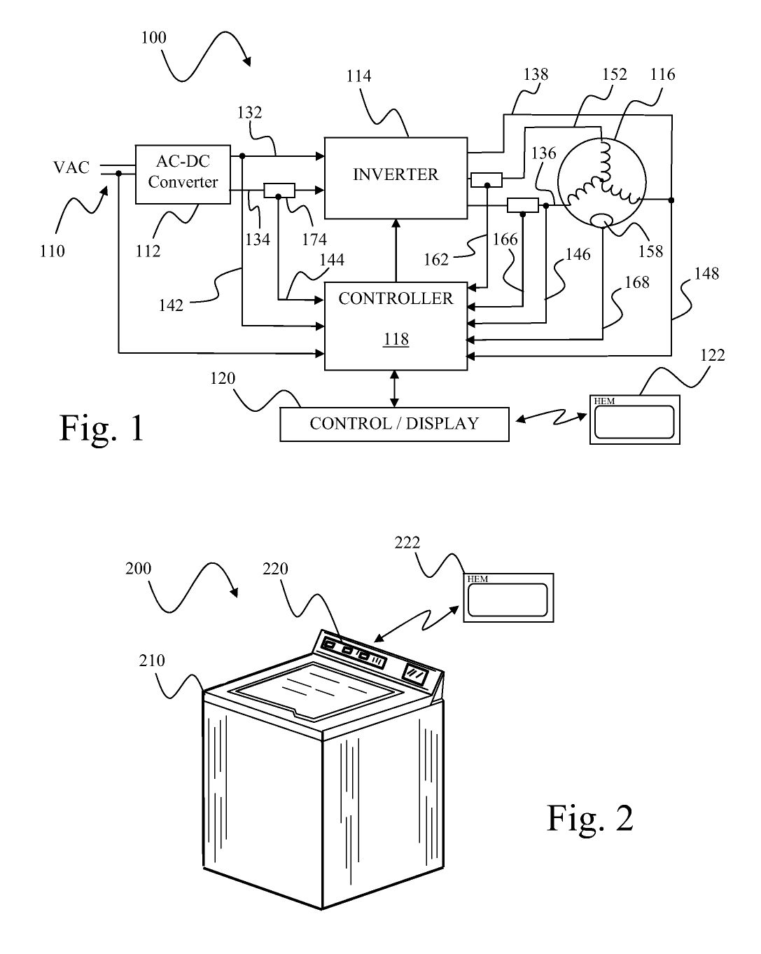

As noted in the Summary section, the present subject matter is directed to methodologies for accurately measuring the real time power and energy usage of a washing machine including the motor and inverter associated with such washing machine. This energy information can then be reported to a Home Energy Monitor or displayed to the consumer through a user interface. With reference to FIG. 1, there is illustrated an exemplary schematic circuit 100 of a portion of a washer control and display circuit and home energy monitor in accordance with present technology.

Generally the washer control circuitry of the present subject matter provides a AC-DC converter 112 that receives input voltage from power input lines 110 generally corresponding to a residential power supply outlet. AC-DC converter 112 supplies direct current along lines 132, 134 to and inverter 114 that, in turn supplies three phase power to a variable speed electronically commutated motor (ECM) 116. Inverter 114 is controlled by controller 118 which, in turn, receives manual operational instructions from a control/display 120.

It should be appreciated that while the present subject matter is described using an exemplary inverter 114 supplying power to a variable speed electronically commutated motor (ECM) 116, other inverter and variable speed motor combinations can be used including, without limitation, inverters configured to supply operating power to brushless DC motors, universal motors, DC motors, phase controlled motors, and single phase induction motors.

Regardless of the specific type of motor employed, controller 118 generates and sends information signals of various types to a motor controlling device, here illustrated as inverter 114, as well as to control/display 120. Such signals to control/display 120 may reflect the present operational status of the washing appliance as well as, in accordance with present technology, a user readable indication of the present actual energy consumption level of the washing appliance. In an alternative embodiment of the present subject matter, energy consumption information, may be sent via controller 118 and/or an interface (not separately illustrated) associated with control/display 120 to a home energy monitor (HEM) 122. Data transmission to HEM 122 may be either by wired or wireless transmission.

HEM 122 may also be configured to receive and display energy consumption data from other consumer (residential) appliances. In this connection, those of ordinary skill in the art should appreciate that while the present disclosure is directed to display of real time actual energy consumption in a washing machine, such technology may also be applied to other appliances including, without limitation, dish washers, refrigerators, electric ranges, microwaves, and generally any other consumer appliance. Any and all of such additional appliances may be configured to send data to HEM 122 for display.

For many loads, tracking energy usage is straightforward since, generally, determination of the power that the loads consume involves a relatively simple power and time calculation. With respect to washing machines, however, a number of variables may complicate such calculations. Such variables include, without limitation, the motor/inverter load size, the present state of out-of-balance (OOB), the spin speed and other factors, all having potentially adverse impacts on the energy used as well as the accuracy of real time calculations of energy using common employed relatively simplistic calculation techniques based on input voltage and current to the entire washing machine delivered, for example, by the power connection from a residential outlet supply.

With further reference to FIG. 1, it will be noticed that controller 118, in addition to being configured to send control signals to inverter 114 and send and receive signals to/from control/display 120 also is configured to receive a number of input signals from various portion of circuit 100. For example, controller 118 may receive signals over lines 142, 144, representative of the voltage on line 132 and the current through line 134, respectively. In addition, controller 118 may also receive voltage signals over lines 146, 148 representative of the voltage applied via lines 136, 138 from inverter 114 to motor 116 as well as from lines 162, 166, representative of current flow through lines 152, 136, respectively, from inverter 114 to motor 116.

Additional signals representing voltage from line 152 and current in line 138 may also be supplied but are omitted here for simplicity of illustration. Other signals may also be supplied to controller 118 including, for example, a speed signal along line 168 from speed sensor 158. Speed sensor 158 may be associated with an output shaft (unillustrated) of motor 116 or, alternatively, associated with a basket and/or agitator (both unillustrated) driven by motor 116.

In accordance with the present subject matter, operational characteristics of the inverter may be used to make measurements of the actual real time power and energy being consumed. Such calculations may be performed using a number of techniques. In one embodiment, measurement of the output power of inverter 114, that is, the power delivered to motor 116, may be accomplished by directly measuring the phase currents in lines 136, 138, 152 and using the output voltage from inverter 114 on the same lines as a function of bus voltage and duty cycle to calculate instantaneous power. This instantaneous power may then be used to calculate real time energy consumption.

In a second embodiment, output torque of motor 116 may be measured and used along with speed from speed sensor 158 to calculate power as Torque x Speed.

In a third embodiment, motor impedance may be assumed while the inverter 114 output current is actually measured and then used to calculate power as current squared times the impedance.

In a forth embodiment, the high voltage DC bus voltage from AC-DC converter 132 to inverter 114 may be measured along with the ripple voltage to calculate the power being consumed from lines 132, 134 (i=C dV/dt). This power would be used to calculate energy used over time.

In a fifth embodiment DC bus current to inverter 114 from AC-DC converter 112 through, for example, line 134 may be measured directly along with the DC bus voltage on line 132 and used to calculate power. In this embodiment, a current sensor 174 may be provided using, for example, a current shunt circuit, a current transformer, a hall sensor, or other appropriate sensor. This calculated power may then be used to calculate energy used over time.

In a sixth embodiment, inertia and out of balance mass measurements may be used to estimate power being used to spin at given speeds and accelerate from one speed to another. This power would be used to calculate energy used over time.

With brief reference to FIG. 2, there is illustrated a representation of an exemplary washing appliance and home energy monitoring system 200 in accordance with present technology. As may be seen, a washing appliance 210 may be provided with a control/display panel 220 corresponding to control/display 120 of FIG. 1. In addition, home energy monitor (HEM) 222 may be coupled directly or by way of wireless connection to washing appliance 210 to provide a display of real time energy usage as described herein above with reference to FIG. 1.

Numerous advantages may be obtained from the use of the present subject matter including the accurate measurement of energy and power usage in a washer as described previously. In addition to providing a real time display of energy as a feature in the washer user interface and/or via a Home Energy Monitor, advantages may be seen in the use of the present methodology in demand side management and/or Smart Grid systems as such accurate energy usage may also be communicated upstream for power provided use in estimating ongoing energy supply requirements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for measuring energy usage in an appliance, comprising:
providing an AC-DC converter configured to receive an alternating current input voltage and to produce a high voltage direct current voltage;
providing an inverter configured to receive the high voltage direct current produced by the AC-DC converter and to provide a controllably variable alternating current output voltage;
providing a controller configured to provide inverter controlling signals to the inverter and to receive energy consumption related signals based at least in part on energy usage of the inverter;
providing a display coupled to the controller; and
configuring the controller to calculate real time power consumption and to cause the calculated results to be displayed on the display.

2. A method as in claim 1, wherein the display is associated with an appliance control panel.

3. A method as in claim 1, wherein the display is coupled to the controller through a wireless connection.

4. A method as in claim 1, wherein the display is a home energy monitor.

5. A method as in claim 1, further comprising:
coupling a variable speed motor to the inverter to receive power there from; and
configuring the controller to calculate real time power consumption based on the output power of the inverter delivered to the motor.

6. A method as in claim 5, wherein the variable speed motor is an electronically commutated motor.

7. A method as in claim 1, further comprising:
coupling a variable speed motor to the inverter to receive power there from;
associating a speed sensor with the motor; and
configuring the controller to calculate real time power consumption based on the speed of the motor and the torque produced by the motor.

8. A method as in claim 1, further comprising:
coupling a variable speed motor to the inverter to receive power there from; and
configuring the controller to calculate real time power consumption based on the current delivered to the motor by the inverter and an assumed value of motor impedance.

9. A method as in claim 1, further comprising:
configuring the controller to calculate real time power consumption based on the high voltage direct current voltage from the AC-DC converter and a ripple voltage thereon.

10. A method as in claim 1, further comprising:
configuring the controller to calculate real time power consumption based on the current and voltage delivered from the AC-DC converter to the inverter.

11. A method as in claim 1, further comprising:
configuring the controller to calculate real time power consumption based on inertia and out of balance mass to calculate power used to spin a basket associated with the appliance at selected speeds and accelerating from one speed to another.

12. An appliance, comprising:
an AC-DC converter configured to receive an alternating current input voltage and to produce a high voltage direct current voltage;
an inverter configured to receive the high voltage direct current produced by the AC-DC converter and to provide a controllably variable alternating current output voltage;
a controller configured to provide inverter controlling signals to the inverter and to receive energy consumption related signals based at least in part on energy usage of the inverter; and
a display coupled to the controller;
wherein the controller is configured to calculate real time power consumption and to cause the calculated results to be displayed on the display.

13. An appliance as in claim 12, wherein the display is wirelessly coupled to the controller.

14. An appliance as in claim 13, wherein the display is a home energy monitor.

15. An appliance as in claim 12, further comprising:
a control panel associated with the display,
wherein the control panel is configured to receive user commands to direct operations of the appliance.
